(19) United States
(12) Patent Application Publication
(10) Pub. No.: US 2014/0069954 A1
(43) Pub. Date: Mar. 13, 2014

(54) Chilled Beverage Dispenser

(71) Applicant: Jeffrey Stein, Moreland Hills, OH (US)

(72) Inventor: Jeffrey Stein, Moreland Hills, OH (US)

(21) Appl. No.: 14/021,374

(22) Filed: Sep. 9, 2013

Related U.S. Application Data
(60) Provisional application No. 61/698,051, filed on Sep. 7, 2012.

(51) Int. Cl. B67D 3/00; B67D 7/84; B67D 7/06; B67D 7/80

(52) U.S. Cl. CPC B67D 3/0009
USPC 222/146.6; 222/167; 222/185.1; 222/481.5

(57) ABSTRACT

A liquid condiment dispenser is provided having a base and a storage container pivotally coupled to the base by a pivot apparatus. The storage container is hollow with an opening for accepting a condiment container. A cooling device coupled to the storage container selectively cools an interior portion of the storage container. A lid in selective engagement with the storage container selectively seals the opening of the storage container and generally confines the condiment container within the interior portion of the storage container. A dispensing tube apparatus provides two fluid ducts between an interior volume of the condiment container and an exterior atmosphere. The dispensing tube apparatus is selectively coupled to the dispensing tap that is operably coupled to the lid. The dispensing tap selectively blocks the two fluid ducts between the interior volume of the generally rigid condiment container and the atmosphere.

### REFERENCE TO RELATED APPLICATION

This application claims priority to and the benefit of U.S. Provisional Application Ser. No. 61/698,051 which was filed Sep. 7, 2012, entitled “CHILLED BEVERAGE DISPENSER”, the entirety of which is hereby incorporated by reference as if fully set forth herein.

### TECHNICAL FIELD

The present invention relates beverage dispensers, and more specifically to a refrigerated condiment dispenser configured to chill and dispense beverage condiments or other liquids from pre-formed consumer containers.

### BACKGROUND

Many venues such as coffee shops are required to maintain strict temperature controls of liquid beverages, such as beverage condiments including diary creamers. Such temperature controls often include providing dairy creamers in pitchers on coffee prep stations, wherein the pitchers are emptied on a regular, timed, basis in order to ensure freshness and acceptable temperatures of the liquids disposed therein. Such disposal of creamers is often wasteful and expensive.

Some alternatives exist to providing creamers in pitchers, wherein the creamers are chilled by conventional refrigeration means, but such alternatives are often expensive to purchase and operate, and also typically require creamer to be provided in bulk non-consumer packaging. Further, such current alternatives are often difficult to load with creamer and are not suited to small coffee shops having limited space or capabilities/needs for storing large volumes of creamer.

### SUMMARY

The present invention overcomes the limitations of the prior art by providing a system, apparatus, and method for refrigerating and dispensing liquid creamers or other liquid condiments from pre-formed consumer packages. Accordingly, the following presents a simplified summary of the disclosure in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

In accordance with the present disclosure, a liquid condiment dispenser is provided, wherein the liquid condiment dispenser comprises a base and a storage container pivotally coupled to the base. The storage container is generally hollow and configured to selectively retain a pre-formed consumer package therein. The pre-formed consumer package, for example, comprises a generally rigid condiment container, wherein the storage container comprises an opening configured to accept the generally rigid condiment container. The pre-formed consumer package or generally rigid condiment container, for example, can retain a perishable liquid such as a dairy creamer, as well as any other appropriate dispensable liquid.

A pivot apparatus is further provided, wherein the pivot apparatus pivotally couples the storage container to the base. The pivot apparatus, for example, is configured to selectively rotate the storage container with respect to the base about a pivot axis. The storage container, for example, is pivotally coupled to the base along a sidewall of the storage container via the pivot apparatus, wherein the pivot axis and can be configured to be generally perpendicular or parallel to a sidewall of the storage container. The liquid condiment dispenser, for example, can further comprise a detent apparatus configured to limit the selective rotation of the storage container with respect to the base between a load position and a dispense position. In one example, the load position and dispense position are 180 degrees apart.

A cooling device is further operably coupled to the storage container, wherein the cooling device is configured to selectively cool an interior portion of the storage container. The cooling device, for example, comprises a Peltier cooler or other refrigeration mechanism. The cooling device is thereby configured to selectively cool a liquid residing within the pre-formed consumer package. A temperature monitoring device can be further provided and configured to monitor a temperature of the interior portion of the storage container.

In accordance with another aspect, a lid is provided in selective engagement with the storage container, wherein the lid selectively seals the opening of the storage container and generally confines the generally rigid condiment container within the interior portion of the storage container. One or more of the lid and the storage container, for example, can comprise a latch mechanism configured to selectively secure the lid to the storage container. According to another example, the liquid condiment dispenser further comprise thermal insulation associated with one or more of the storage container and lid, wherein the thermal insulation generally inhibits heat transfer between the interior portion of the storage container to the atmosphere when the opening of the storage container is sealed by the lid. According to another exemplary aspect, a dispensing tap is also operably coupled to the lid.

According to another aspect, a dispensing tube apparatus is further provided and configured to selectively engage a port of the generally rigid condiment container. The dispensing tube apparatus is configured to provide first and second fluid ducts between an interior volume of the generally rigid condiment container and an atmosphere that is exterior to the storage container. The dispensing tube apparatus, for example, is further selectively coupled to the dispensing tap, wherein the dispensing tap is configured to selectively block the two fluid ducts between the interior volume of the generally rigid condiment container and the atmosphere, therein selectively blocking and releasing the liquid from the pre-formed consumer package or generally rigid condiment container.

The dispensing tube apparatus, for example, comprises a cap configured to selectively engage the port of the generally rigid condiment container, wherein first and second fluid passages pass through the cap. The first and second fluid passages, for example, are generally parallel to an axis of the cap.

In accordance with another exemplary aspect, the dispensing tube apparatus comprises a vent tube and a liquid tube, therein additionally generally defining the two fluid ducts. The vent tube, for example, is fluidly coupled to the first fluid passage at the first end of the cap, and the liquid tube is associated with the second fluid passage at the first end of the cap. The vent tube can be configured to extend from the port a first distance into the generally rigid condiment container, and the liquid tube can be configured to extend from the port a second distance into the generally rigid condiment container, wherein the first distance is greater than the second distance. The vent tube, for example, can be generally rigid. The first distance, for example, is associated with a length of the generally rigid condiment container, where an air gap can be reached by the vent tube. The second distance, for example, can extend a limited distance into the generally rigid condiment container, such as one inch or less. Alternatively, the liquid tube can be integral to the cap.

According to another aspect, the dispensing tube apparatus comprises first and second compressible tubes respectively fluidly coupled to the first and second fluid passages at a second end of the cap. The first and second compressible tubes, for example, extend away from the second end of the cap to the atmosphere, wherein the first and second compressible tubes are respectively fluidly coupled to the liquid tube and vent tube via the cap. Accordingly, the first fluid passage of the cap, the vent tube, and the first compressible tube generally define a first fluid duct, and the second fluid passage, liquid tube, and second compressible tube generally define the second fluid duct.

Accordingly, the dispensing tap can comprise a pinch assembly configured to selectively compress the first and second compressible tubes, therein selectively blocking fluid flow within the two fluid ducts between the interior volume of the generally rigid condiment container and the atmosphere.

In one example, the first and second compressible tubes are integrally coupled to one another. For example, a dual lumen tube generally defines the first and second compressible tubes, wherein respective lumens of the dual lumen tube are fluidly coupled to the liquid tube and vent tube via the cap. The dual lumen tube, for example is comprised of a diametrically divided cylinder made of an elastomeric material. Alternatively, the dual lumen tube comprises two generally circular tubes tangentially coupled to one another.

In another example, the port of the generally rigid condiment container can comprise a threaded opening. Accordingly, the cap is provided having an engagement portion configured to engage the threaded opening of the generally rigid condiment container. The engagement portion of the cap, for example, can comprise one or more of a thread, a barb, and a compressible seal configured to retain the cap to the port or threaded opening, while the two fluid ducts pass through the cap. The engagement portion of the cap can be further configured to generally prevent a disengagement of the cap from the port once the cap is engaged to the port.

In accordance with another exemplary aspect, a method for dispensing a perishable liquid is provided. The method, for example, comprises providing a liquid condiment dispenser having a storage container pivotally coupled to a base. The storage container is rotated with respect to the base, therein placing the storage container in a loading position, and wherein an opening of the storage container generally faces upwards. A dispensing tube apparatus is attached to a pre-formed consumer package having a liquid residing therein. The pre-formed consumer package is placed within the storage container, and the dispensing tube is coupled to a dispensing tap that is operably coupled to a lid.

The lid is further secured to the opening of the storage container, and the storage container is again rotated with respect to the base. Accordingly, the storage container is thus placed in a dispensing position, wherein the opening of the storage container generally faces downwards, and wherein the dispensing tap selectively permits dispensing of the liquid via an interaction between the dispensing tube apparatus and the dispensing tap and gravity. The liquid residing within the pre-formed consumer package can be further chilled by cooling the storage container.

The above summary is merely intended to give a brief overview of some features of some embodiments of the present invention, and other embodiments may comprise additional and/or different features than the ones mentioned above. In particular, this summary is not to be construed to be limiting the scope of the present application. Thus, to the accomplishment of the foregoing and related ends, the invention comprises the features hereinafter described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates a perspective view of exemplary apparatus for dispensing a liquid from a pre-formed consumer package.

FIG. 2 illustrates an exploded perspective view of exemplary apparatus for dispensing a liquid from a pre-formed consumer package in a load position.

FIG. 3 illustrates a perspective view of exemplary apparatus for dispensing a liquid from a pre-formed consumer package in a partially rotated position.

FIG. 4 illustrates a perspective view of exemplary apparatus for dispensing a liquid from a pre-formed consumer package in a dispense position.

FIG. 5 illustrates a side view of another exemplary apparatus for dispensing a liquid from a pre-formed consumer package.

FIG. 6 illustrates a perspective view of the exemplary apparatus for dispensing a liquid from a pre-formed consumer package of FIG. 5.

FIG. 7 illustrates a perspective view of exemplary apparatus for dispensing a liquid from a pre-formed consumer package in a load position with a lid removed.

FIGS. 8A-8B illustrate perspective views of exemplary lid and dispense tap in respective closed and open positions.

FIGS. 9-10 illustrate perspective views of various exemplary pre-formed consumer packages according to several aspects of the disclosure.

FIG. 11 illustrates a perspective view of an exemplary dispensing tube apparatus according to several aspects of the disclosure.

FIGS. 12A-12B illustrate perspective views of an exemplary cap according to several exemplary aspects.

FIG. 12C illustrates a cross-sectional side view of the cap of FIGS. 12A-12B.

FIG. 12D illustrates an exemplary lumen configured to mate with the cap of FIGS. 12A-12C.

FIGS. 13A-13B illustrate perspective views of an exemplary cap according to several exemplary aspects.

FIG. 13C illustrates a cross-sectional side view of the cap of FIGS. 13A-13B.

FIG. 13D illustrates an exemplary lumen configured to mate with the cap of FIGS. 13A-13C.

FIG. 14A illustrates a side view of another exemplary dispensing tube apparatus according to several aspects of the disclosure.

FIG. 14B illustrates an exploded perspective view of the exemplary dispensing tube apparatus of FIG. 14A according to several aspects of the disclosure.

FIG. 15 illustrates a methodology for chilling and dispensing a liquid from a pre-formed consumer package in accordance with another aspect.

### DETAILED DESCRIPTION

The present disclosure is directed generally toward an apparatus, system, and method refrigerating and dispensing condiments such as coffee creamers or other condiments directly from a pre-formed consumer package. Accordingly, the present invention will now be described with reference to the drawings, wherein like reference numerals may be used to refer to like elements throughout. It is to be understood that the description of these aspects are merely illustrative and that they should not be interpreted in a limiting sense. In the following description, for purposes of explanation, numerous specific details are set forth in order to provide a thorough understanding of the present invention. It will be evident to one skilled in the art, however, that the present invention may be practiced without these specific details. Further, the scope of the invention is not intended to be limited by the embodiments or examples described hereinafter with reference to the accompanying drawings, but is intended to be only limited by the appended claims and equivalents thereof.

It is also noted that the drawings are provided to give an illustration of some aspects of embodiments of the present disclosure and therefore are to be regarded as schematic only. In particular, the elements shown in the drawings are not necessarily to scale with each other, and the placement of various elements in the drawings is chosen to provide a clear understanding of the respective embodiment and is not to be construed as necessarily being a representation of the actual relative locations of the various components in implementations according to an embodiment of the invention. Furthermore, the features of the various embodiments and examples described herein may be combined with each other unless specifically noted otherwise.

It is also to be understood that in the following description, any direct connection or coupling between functional blocks, devices, components, circuit elements or other physical or functional units shown in the drawings or described herein could also be implemented by an indirect connection or coupling. Furthermore, it is to be appreciated that functional blocks or units shown in the drawings may be implemented as separate features or circuits in one embodiment, and may also or alternatively be fully or partially implemented in a common feature or circuit in another embodiment.

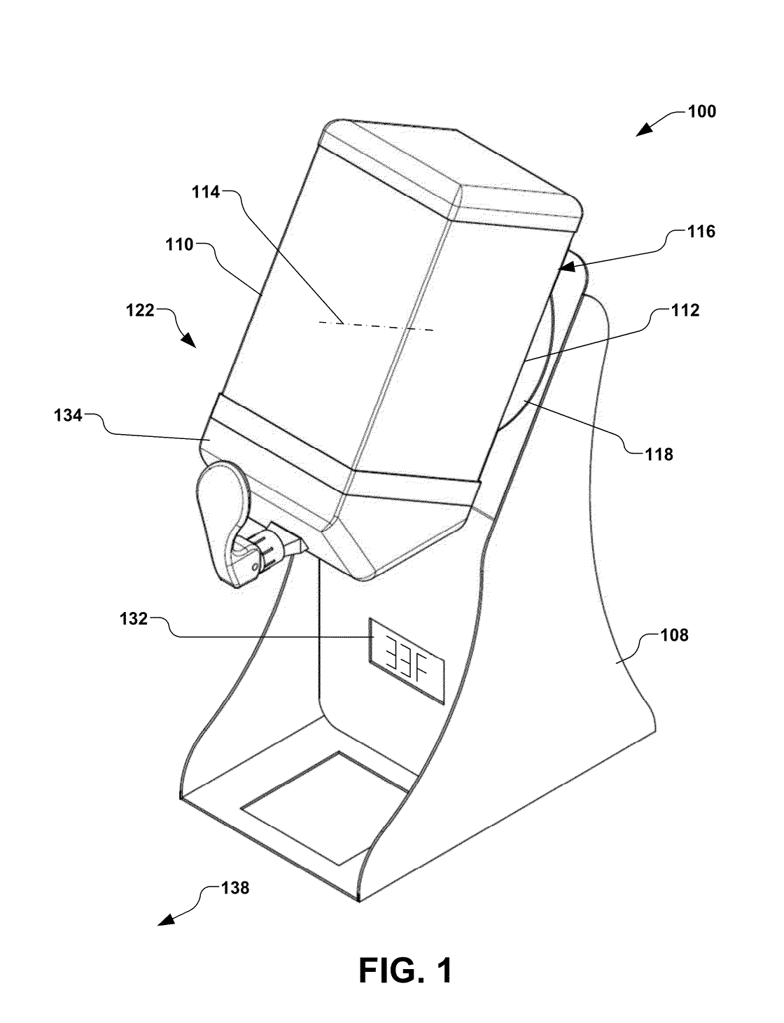

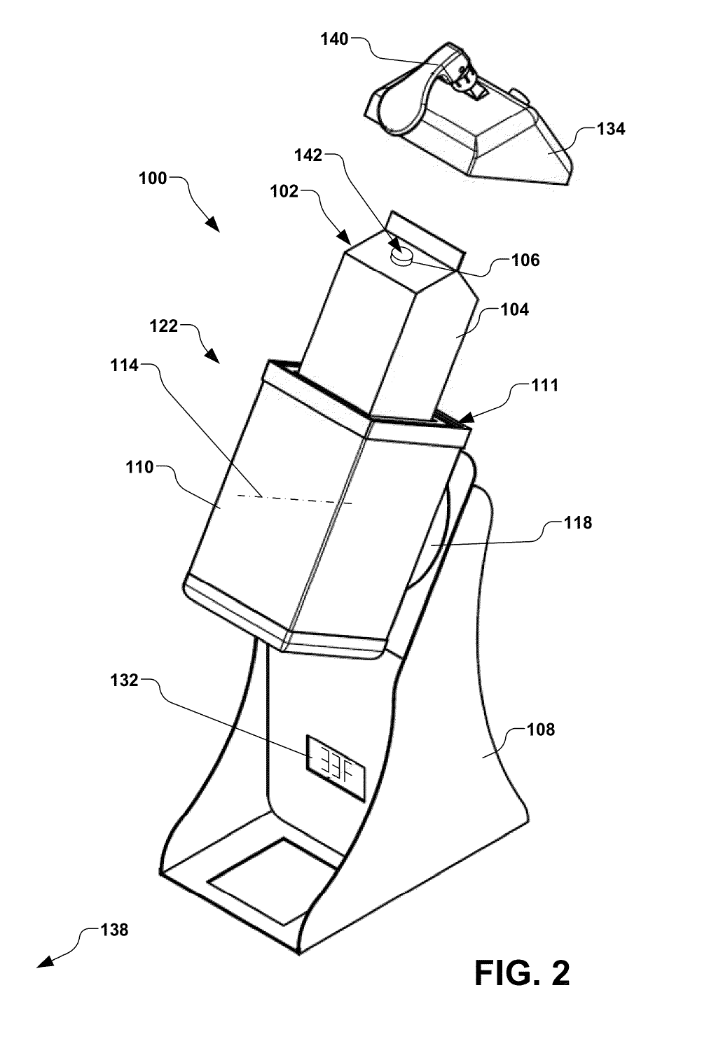

In accordance with one aspect of the invention, an exemplary liquid condiment dispenser 100 is illustrated in FIG. 1. The liquid condiment dispenser 100, for example, is suitable for accommodating a pre-formed consumer package 102 utilized in conventional transport and manual serving of liquids such as dairy creamers, milk, juice, or other liquids, as illustrated in FIG. 2. In a preferred embodiment, the pre-formed consumer package 102 comprises a generally rigid condiment container 104. The generally rigid condiment container 104, for example, can comprise a liquid-proof cardboard container, plastic container, or other generally rigid container for holding perishable or non-perishable liquids such as milk, dairy cream, non-dairy creamer, etc., and can be provided in a variety of holding capacities, such as quart, half-gallon, and gallon sizes typically available for purchase at a local grocery store or restaurant supply location. In one example, the generally rigid condiment container 104 is typically provided with a screw-top dispensing port 106 having a sealing lid (not shown), as will be known by an ordinary consumer of liquid beverages.

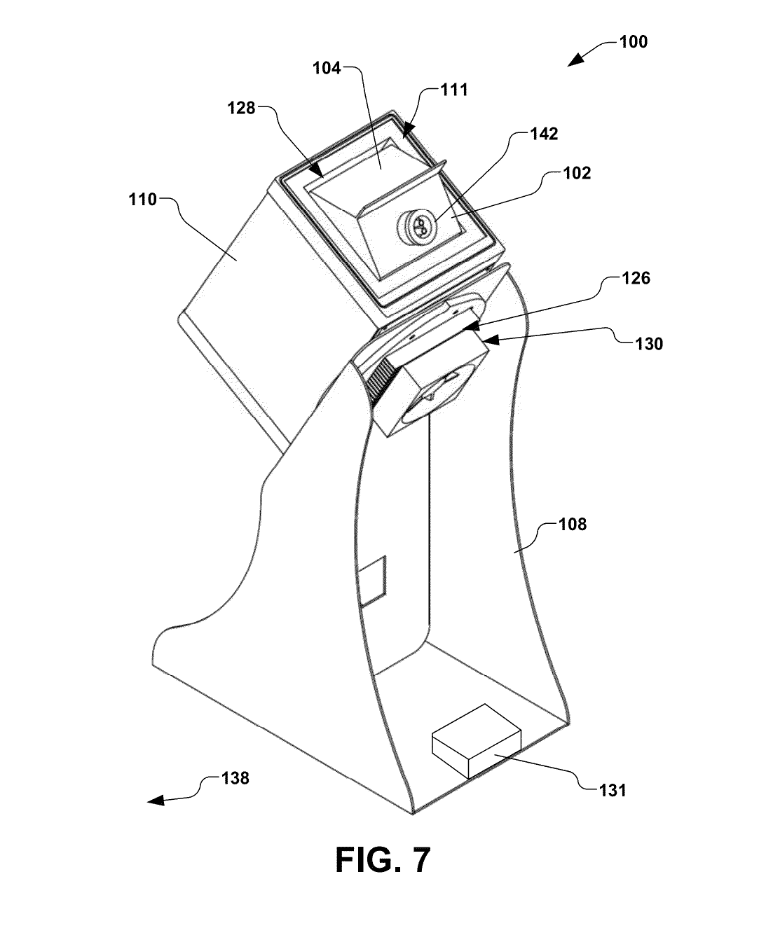

According to one example, the liquid condiment dispenser 100 of FIGS. 1 and 2 comprises a base 108, wherein the base is configured to be placed on a table or stand in a restaurant, coffee shop, or other location. A storage container 110 is further provided, wherein the storage container is pivotally coupled to the base 108. The storage container 110, for example, is generally hollow and configured to selectively retain the generally rigid condiment container 104 therein. The storage container 110 comprises an opening 111 shown in FIGS. 2 and 7 configured to accept the generally rigid condiment container 102.

It should be noted that in various embodiments, the storage container 110 can be sized to accept a plurality of sizes of the generally rigid condiment container 102. For example, the storage container 110 can be sized to retain a larger generally rigid condiment container 102 (e.g., a half-gallon size carton), wherein spacers (not shown) can be inserted into the opening 111 to also accommodate a smaller-sized generally rigid condiment container 102 (e.g., one-quart size). For example, constraints (not shown) such as wires, guides, springs, or friction-fit mechanisms may be provided to securely retain the generally rigid condiment container 104 within the storage container 110. Alternatively, the various sizes of the storage container 110 can be provided for various respective sizes of generally rigid condiment containers 102.

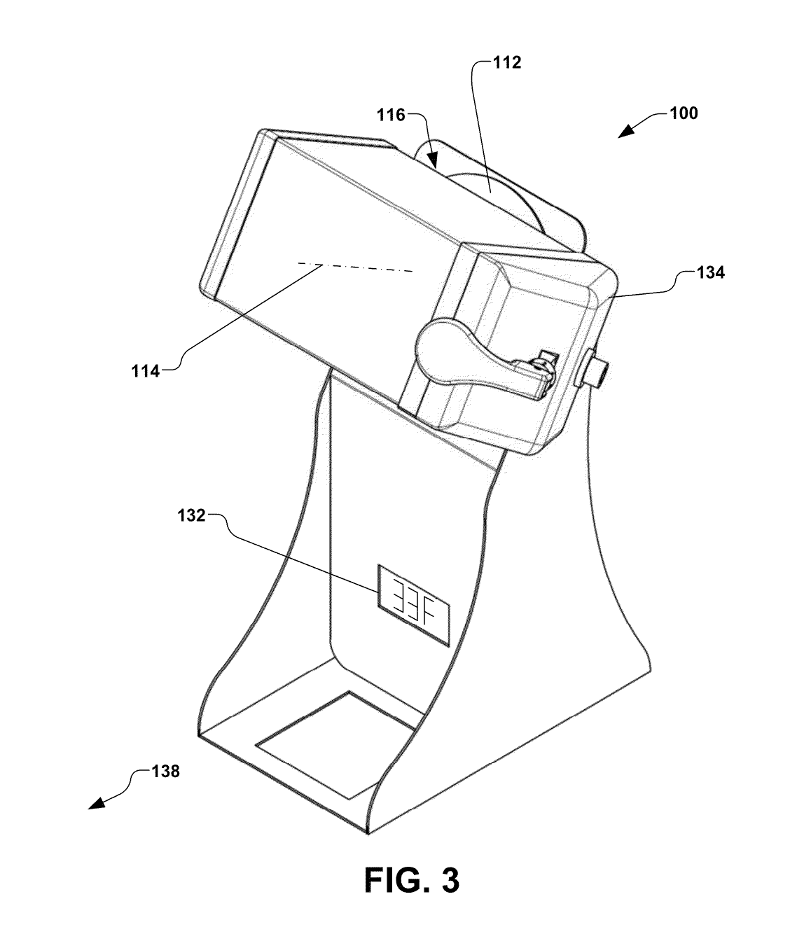

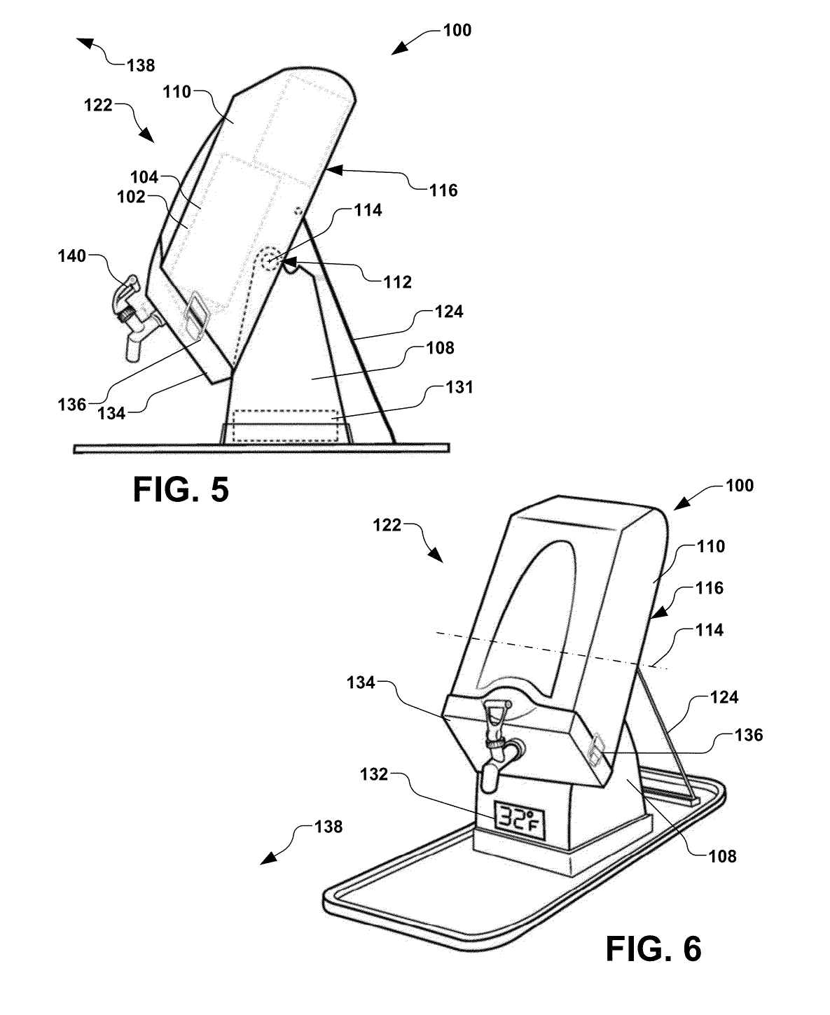

The storage container 110, for example, is pivotally coupled to the base 108 via a pivot apparatus 112. The pivot apparatus 112, for example, is configured to selectively rotate the storage container 110 with respect to the base 108 about a pivot axis 114, as illustrated in various orientations in FIGS. 1, 3, and 4. The storage container 110, for example, is pivotally coupled to the base 108 along a sidewall 116 of the storage container via the pivot apparatus 112. The pivot axis 114 and can be configured to be generally perpendicular to the sidewall of the storage container 110, as illustrated in FIGS. 1, 3, and 4. Alternatively, the pivot apparatus 112 can be configured such that the pivot axis 114 is generally parallel to the sidewall 116 of the storage container 110, as illustrated in FIGS. 5 and 6.

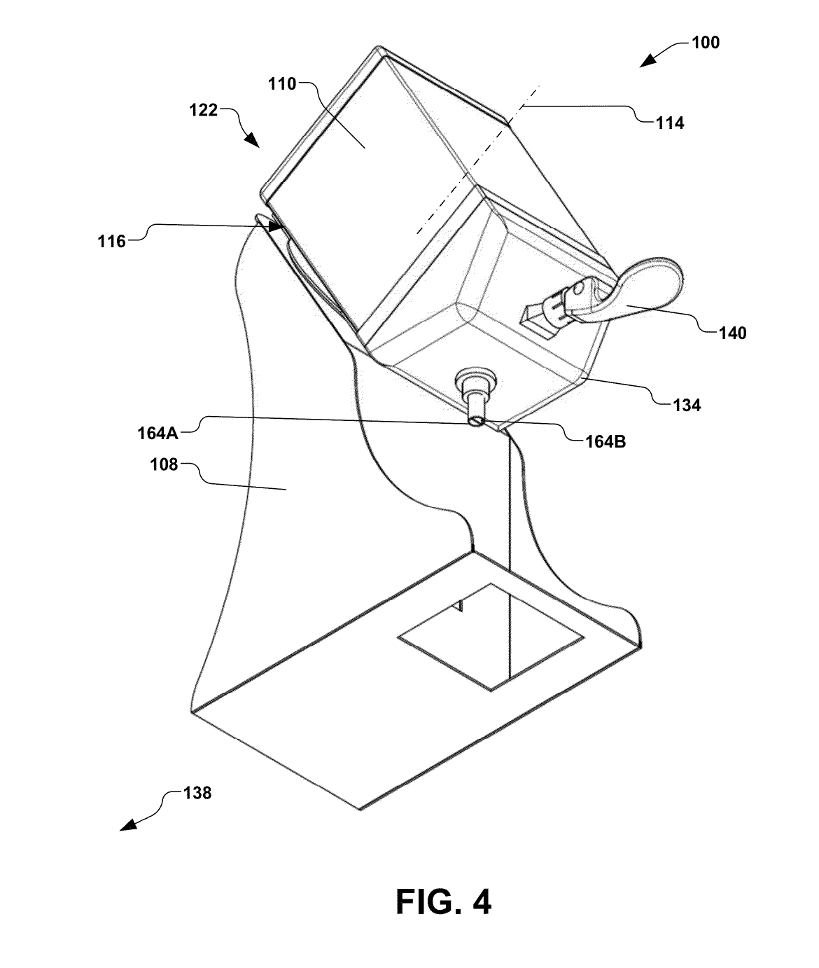

The liquid condiment dispenser 100 of FIG. 1, for example, can further comprise a detent apparatus 118 configured to limit the selective rotation of the storage container 110 with respect to the base 110 between a load position 120 illustrated in FIG. 2 and a dispense position 122 illustrated in FIGS. 1 and 4. In the present example, the load position 120 of FIG. 2 and the dispense position 122 of FIG. 4 are 180 degrees apart. In the example of FIGS. 5 and 6, the detent apparatus 118 comprises a bar 124 configured to selectively support the storage container in the dispense position 122. The bar 124 can be selectively moved to present the storage container 110 in various other positions, including the load position (not shown), where the storage container is rotated about the pivot axis 114. As such, the storage container 110 is configured to rotate and/or translate in order to easily load and unload the generally rigid condiment container 104 such that the pre-formed consumer package 102 remains upright during loading and unloading thereof, thus minimizing occurrences of spillage.

A cooling device 126, for example, is further operably coupled to the storage container 110, wherein the cooling device is configured to selectively cool an interior portion or volume 128 of the storage container, as illustrated in FIG. 7. As such, the cooling device 126 is configured to cool or chill a liquid (e.g., coffee creamer, dairy products, juice, etc.) residing within the generally rigid condiment container 104. The cooling device 126, for example, comprises a Peltier device 130 having associated controllers 131, as well as fans, heat transfer plates, power supplies, and the like, which are not shown in detail for purposes of clarity. Alternatively, the cooling device 126 can comprise other refrigeration mechanisms (not shown), such as compressed gas systems, or even ice. Further, a temperature monitoring device 132 may be provided and configured to monitor and/or display a temperature of the interior portion 128 of the storage container 110, and thus, a temperature of the liquid within the pre-formed consumer package 102.

According to another exemplary aspect of the disclosure, a lid 134 is in selective engagement with the storage container 110, as illustrated in the exploded view of FIG. 2, wherein the lid selectively seals the opening 111 of the storage container and generally confines the generally rigid condiment container 104 within the interior portion 128 the storage container. One or more of the lid 134 and the storage container 110, for example, can comprise a latch mechanism 136 (e.g., illustrated in FIGS. 5-6) configured to selectively secure the lid to the storage container. According to another example, the liquid condiment dispenser 100 of the present disclosure further comprise thermal insulation (e.g., fiberglass, foam, gas, or a vacuum) associated with one or more of the storage container 110 and lid 134, wherein the thermal insulation generally inhibits heat transfer between the interior portion 128 of the storage container to the atmosphere 138 when the opening 111 of the storage container is sealed by the lid.

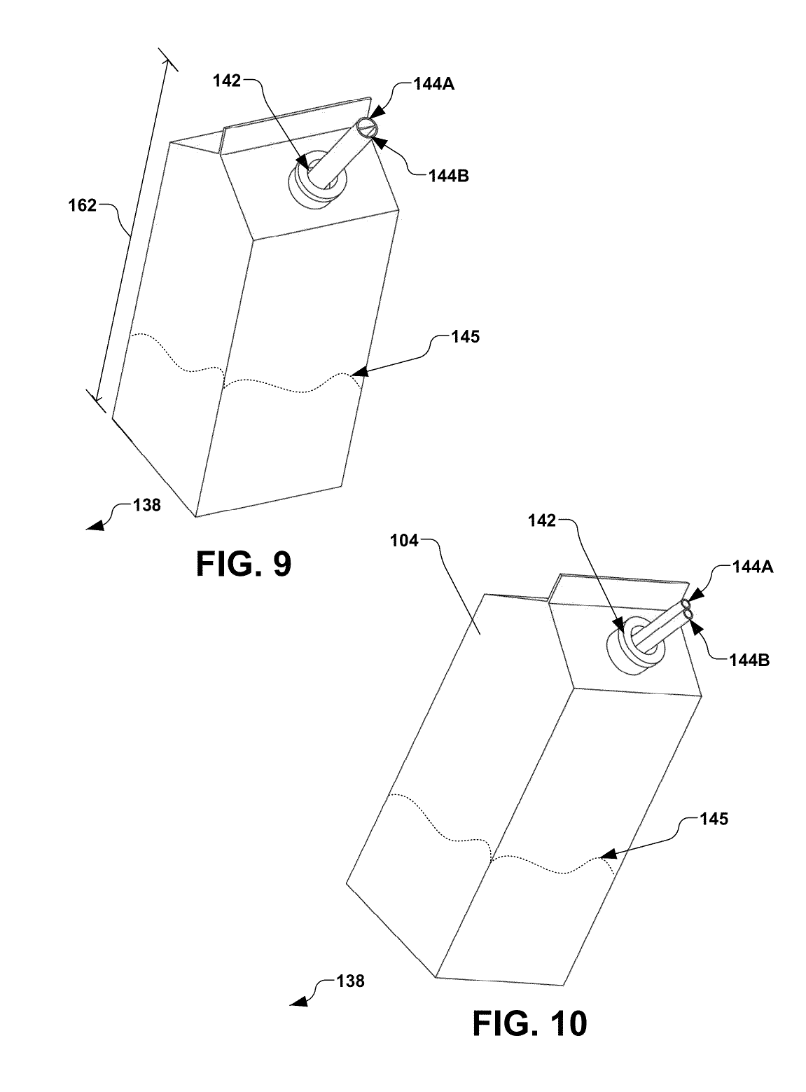

A dispensing tap 140 is further operably coupled to the lid 134, and a dispensing tube apparatus 142 is provided and configured to selectively engage the dispensing port 106 of the, as illustrated in FIG. 2. The dispensing tube apparatus 142, in conjunction with the dispensing tap 140, for example, is configured to selectively release the liquid from the generally rigid condiment container 104, as will be further appreciated hereafter. The dispensing tube apparatus 142, as illustrated in FIGS. 9-11, for example, is configured to provide first and second fluid ducts 144A, 144B between an interior volume 145 of the generally rigid condiment container 104 and 138 atmosphere 138 that is exterior to the storage container 110. The dispensing tube apparatus 142, for example, is further selectively coupled to the dispensing tap 140 of FIG. 2, wherein the dispensing tap is configured to selectively block the two fluid ducts 144A, 144B of FIGS. 9-11 between the interior portion 128 (e.g., illustrated in FIG. 7) of the generally rigid condiment container 104 and the atmosphere 138, therein selectively blocking and releasing the liquid from the pre-formed consumer package 102 or generally rigid condiment container 104.

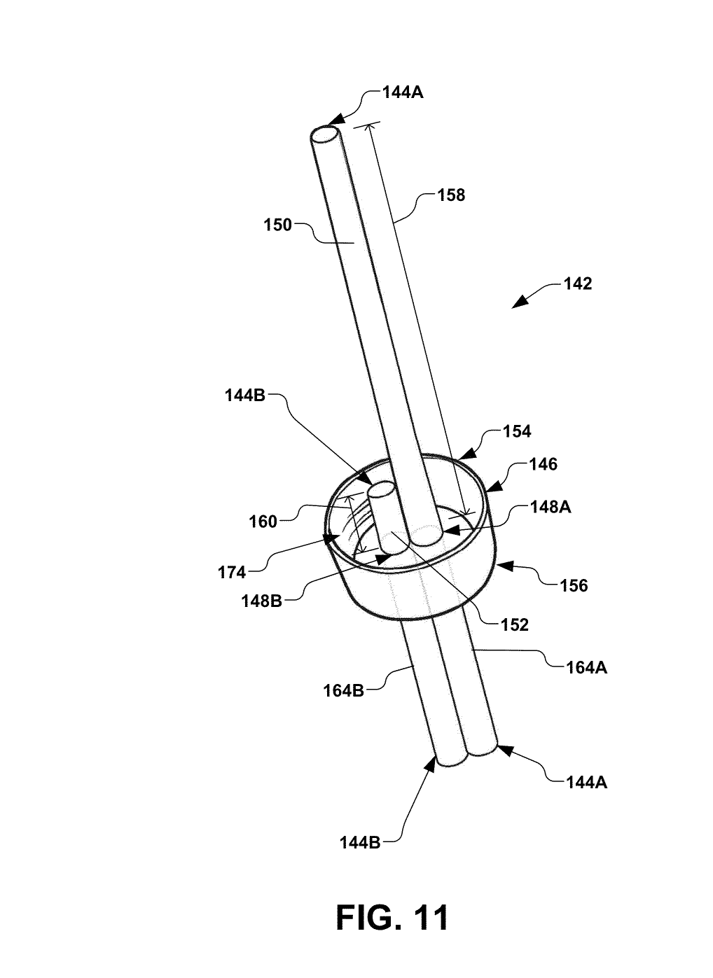

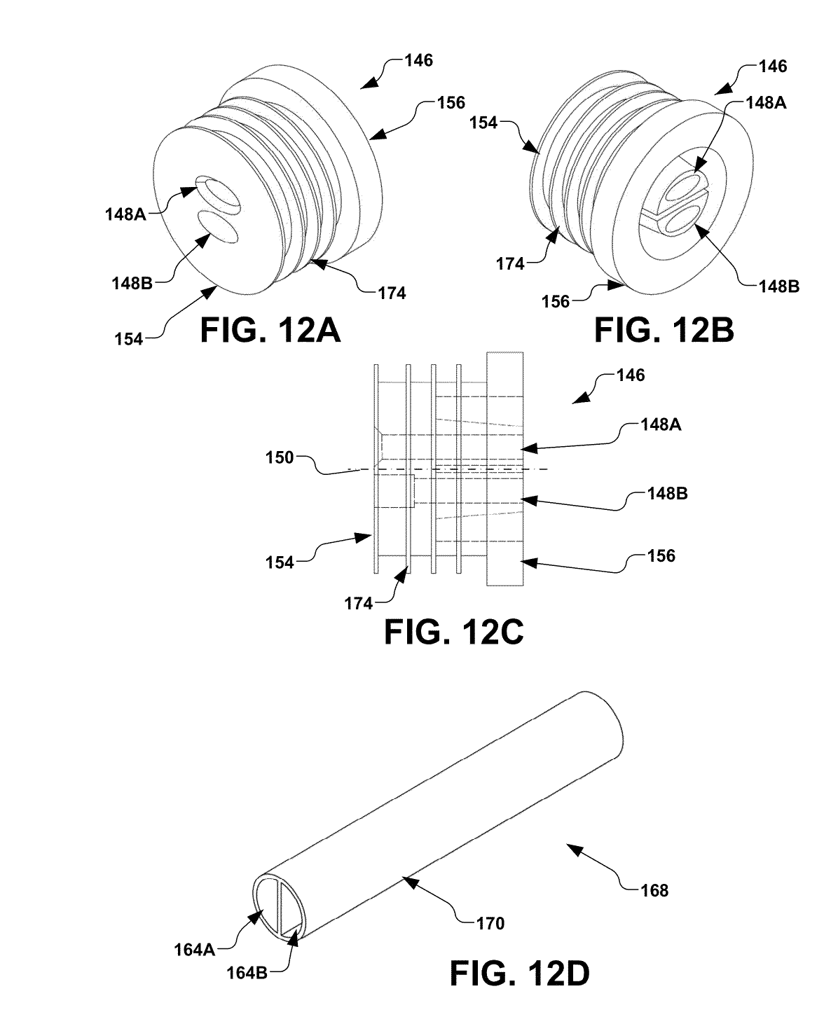

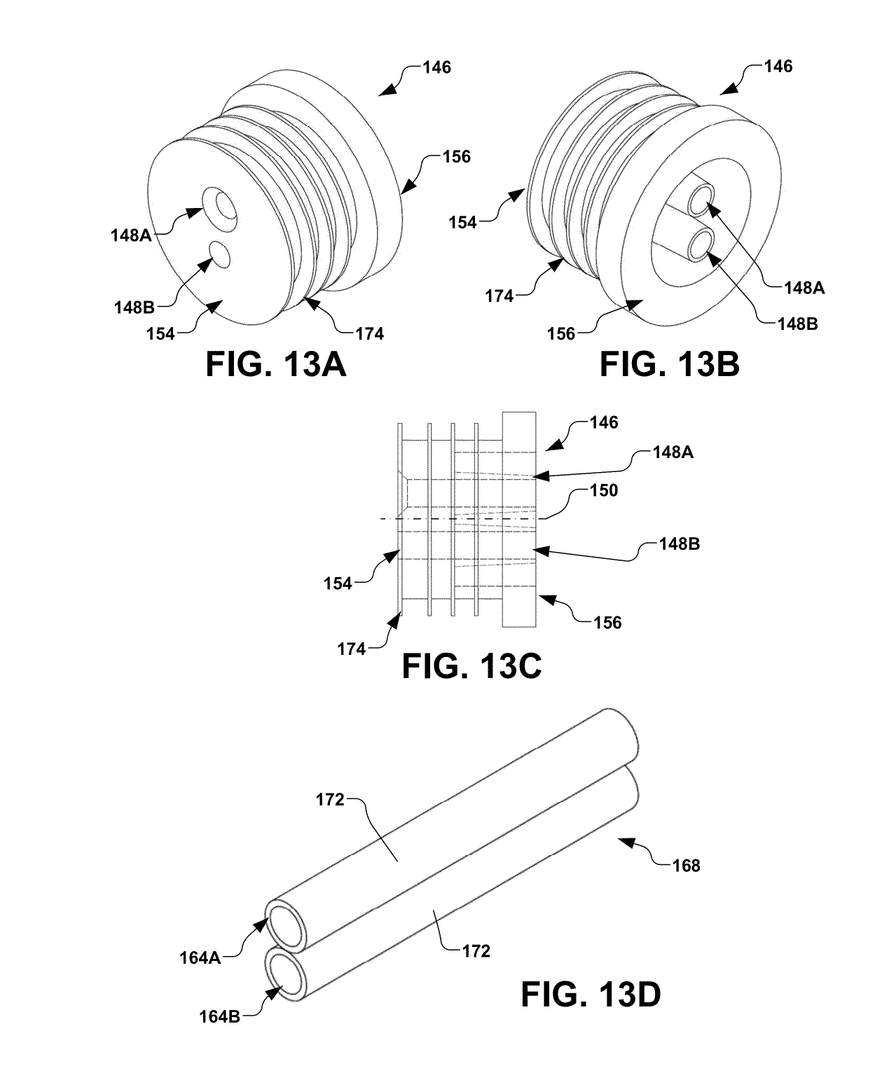

The exemplary dispensing tube apparatus 142 of FIG. 11, for example, comprises a cap 146 configured to selectively engage the port 106 of the generally rigid condiment container 104 of FIG. 2, wherein first and second fluid passages 148A, 148B are provided passing through the cap. The first and second fluid passages 148A, 148B, for example, are generally parallel to an axis 150 of the cap 146, as illustrated in FIGS. 12A-12C and 13A-13C.

In accordance with another exemplary aspect, the dispensing tube apparatus 142 of FIG. 11 further comprises a vent tube 150 and a liquid tube 152, therein additionally generally defining the two fluid ducts 144A, 144B. The vent tube 150, for example, is fluidly coupled to the first fluid passage 148A at a first end 154 of the cap 146, and the liquid tube 152 is associated with the second fluid passage 148B at a second end 156 of the cap, as illustrated in FIGS. 11, 12A-12C and 13A-13C. The vent tube 150 of FIG. 11, for example, can be configured to extend from the port 106 of FIG. 2 a first distance 158 (illustrated in FIG. 11) into the generally rigid condiment container 104, and the liquid tube 152 can be configured to extend from the port a second distance 160 into the generally rigid condiment container, wherein the first distance is greater than the second distance. The vent tube 150, for example, can be generally rigid. Regardless, the vent tube 150 generally defines a vacuum break device, wherein vacuum within the generally rigid condiment container 104 is generally relieved via the vent tube.

The first distance 158 of FIG. 11, for example, is associated with a length 162 (illustrated in FIG. 9) of the generally rigid condiment container 104, where an air gap can be reached by the vent tube when the generally rigid condiment container is in the dispense position of FIG. 1. The second distance 160 of FIG. 11, for example, can extend a limited distance into the generally rigid condiment container, such as one inch or less. Alternatively, the liquid tube 152 can be integral to the cap 146, and can be flush with the first end 154 thereof.

According to another aspect, the dispensing tube apparatus 142 of FIG. 11 comprises first and second compressible tubes 164A, 164B (also called squeeze tubes) that are respectively fluidly coupled to the first and second fluid passages 148A, 148B at a second end 156 of the cap. The first and second compressible tubes 164A, 164B of FIGS. 4, 11, 12D, and 13D, for example, extend away from the second end 156 of the cap 146 of FIG. 11 to the atmosphere 138 of FIG. 4, wherein the first and second compressible tubes are respectively fluidly coupled to the vent tube 150 and liquid tube 152 via the cap 146. Accordingly, the first fluid passage 148A of the cap 146, the vent tube 150, and the first compressible tube 164A generally define a first fluid duct 144A, and the second fluid passage 148B of the cap, the liquid tube 152, and the second compressible tube 164B generally define the second fluid duct 144B. The first and second compressible tubes 164A, 164B, for example, are generally compressible and elastic, and are comprised of a food-grade elastomeric material.

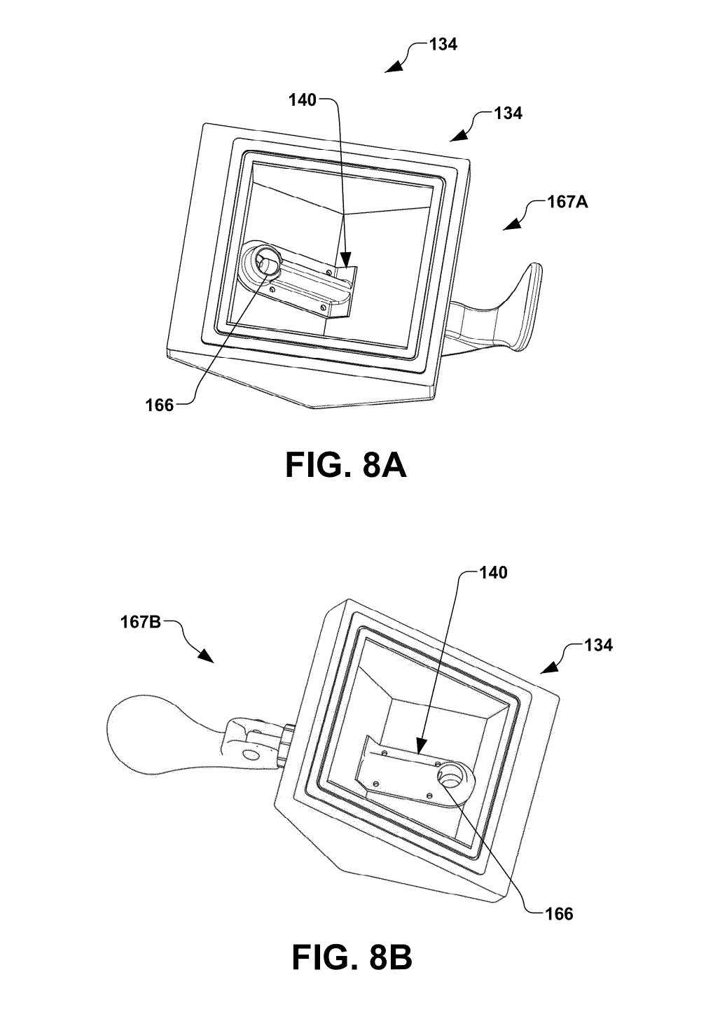

Accordingly, the dispensing tap 140 of FIGS. 8A-8B, for example, can comprise a pinch assembly 166 configured to selectively compress the first and second compressible tubes 164A, 164B, therein selectively blocking fluid flow within the two fluid ducts 144A, 144B between the interior volume 145 of the generally rigid condiment container 104 of FIGS. 9-10 and the atmosphere 138. FIG. 8A illustrates the pinch assembly 166 and dispensing tap 140 in a closed position 167A, while FIG. 8B illustrates the pinch assembly and dispensing tap in a dispense, or open position 167B.

In another example, the first and second compressible tubes 164A, 164B are integrally coupled to one another, as illustrated in FIGS. 12D and 13D. For example, a dual lumen tube 168 generally defines the first and second compressible tubes 164A, 164B, wherein respective lumens 170A, 170B of the dual lumen tube are fluidly coupled to the vent tube 150 and liquid tube 152 via the cap 146 of respective FIGS. 12A-12C and 13A-13C. The dual lumen tube 168 of FIG. 12D, for example, is comprised of a diametrically divided cylinder 170 made of an elastomeric material. Alternatively, the dual lumen tube 168 of FIG. 13D comprises two generally circular tubes 172 tangentially coupled to one another. In still another alternative, the compressible tubes 164A, 164B are distinct and separate from one another.

In accordance with yet another exemplary aspect of the disclosure, the port 106 of the generally rigid condiment container 104 can comprise a threaded opening (not shown). Accordingly, the cap 146 of FIG. 11 is provided having an engagement portion 174 configured to engage the threaded opening of the generally rigid condiment container 104. The engagement portion 174 of the cap 146 of FIGS. 12A-12C and 13A-13C, for example, can comprise one or more of a thread, a barb, and a compressible seal configured to retain the cap to the port or threaded opening, while the two fluid ducts 144A, 144B pass through the cap. The engagement portion 174 of the cap 146, for example, can be further configured to generally prevent a disengagement of the cap from the port 106 of FIG. 2 once the cap is engaged to the port. Such a prevention of disengagement can be beneficial to prevent cross-contamination between generally rigid condiment containers 104, thus making the dispensing tube apparatus 142 a generally disposable item.

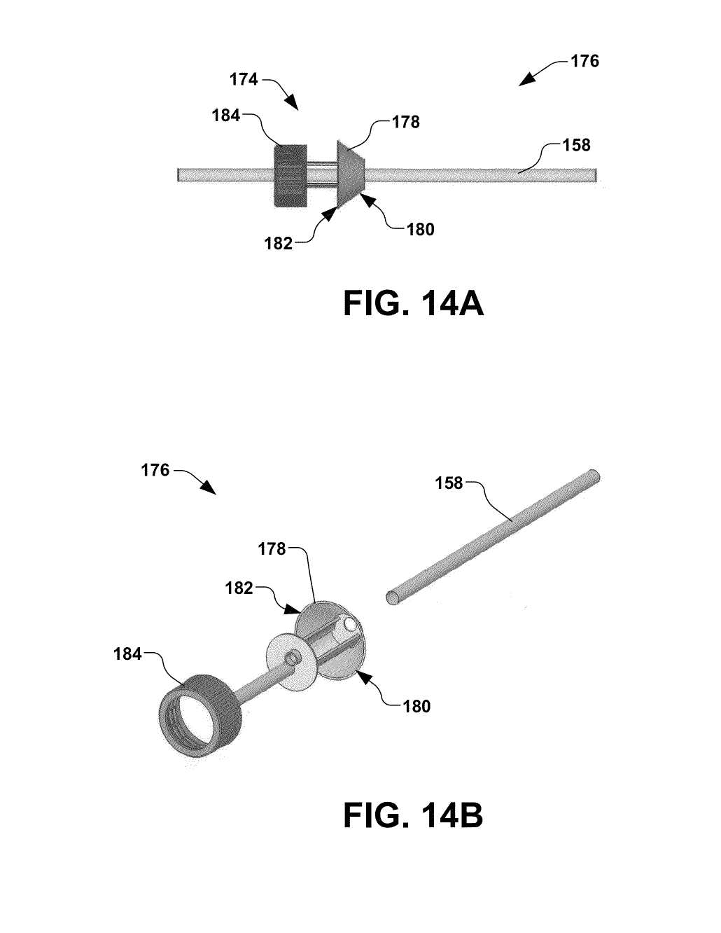

For example, another exemplary dispensing tube apparatus 176 is illustrated in FIGS. 14A and 14B, wherein the engagement portion 174 of the cap 146 comprises a one-way plug 178. The one-way plug 178 comprises a conical portion 180 configured to allow the engagement portion 174 to be inserted into the port 106 of FIG. 2, and wherein a wide portion 182 generally prevents the engagement portion from removal, once inserted. A screw cap 184 of FIGS. 14A and 14B is configured to engage the threads of the port 106, therein securing the dispensing tube apparatus to the generally rigid condiment container 104.

Alternatively, in yet another example, the dispensing tube apparatus 142 of FIG. 11 can be re-used when the engagement portion 174 of the cap 146 is threaded or otherwise removable from the generally rigid condiment container 104.

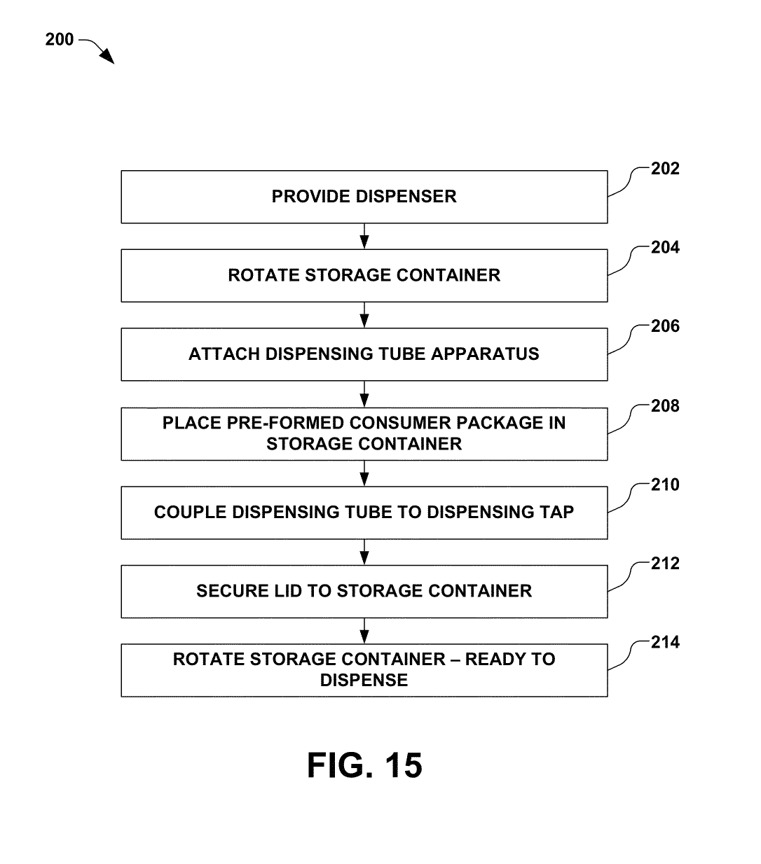

In accordance with another exemplary aspect of the invention, FIG. 15 illustrates an exemplary method 200 for dispensing a perishable liquid. It should be noted that while exemplary methods are illustrated and described herein as a series of acts or events, it will be appreciated that the present invention is not limited by the illustrated ordering of such acts or events, as some steps may occur in different orders and/or concurrently with other steps apart from that shown and described herein, in accordance with the invention. In addition, not all illustrated steps may be required to implement a methodology in accordance with the present invention. Moreover, it will be appreciated that the methods may be implemented in association with the systems illustrated and described herein as well as in association with other systems not illustrated.

The method 200 of FIG. 15 begins at act 202, wherein a liquid condiment dispenser is provided having a storage container pivotally coupled to a base. In act 204, the storage container is rotated with respect to the base, therein placing the storage container in a loading position, wherein an opening of the storage container generally faces upwards. In act 206, a dispensing tube apparatus is attached to a pre-formed consumer package having a liquid residing therein. The pre-formed consumer package, for example, comprises a dairy creamer container containing a dairy or non-dairy creamer therein.

In act 208, the pre-formed consumer package is placed within the storage container, and in act 210, the dispensing tube is coupled to a dispensing tap that is operably coupled to a lid. The method 200 may further comprise selectively cooling the storage container, therein selectively cooling the liquid residing within the pre-formed consumer package. The dispensing tube, for example, comprises a squeeze tube that is fed through the dispensing tap, wherein the dispensing tap is configured to selectively pinch the squeeze tube.

In act 212, the lid is secured to the opening of the storage container, and in act 214, the storage container is again rotated with respect to the base, therein placing the storage container in a dispensing position. In the dispensing position, the opening of the storage container generally faces downwards, wherein the dispensing tap selectively permits dispensing of the liquid via an interaction between the dispensing tube apparatus and the dispensing tap and gravity.

Although the invention has been shown and described with respect to a certain embodiment or embodiments, it should be noted that the above-described embodiments serve only as examples for implementations of some embodiments of the present invention, and the application of the present invention is not restricted to these embodiments. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application. Accordingly, the present invention is not to be limited to the above-described embodiments, but is intended to be limited only by the appended claims and equivalents thereof.

1. A liquid condiment dispenser, comprising:
a base;
a storage container, wherein the storage container is generally hollow and comprises an opening configured to accept a generally rigid condiment container;
a pivot apparatus pivotally coupling the storage container to the base, wherein the pivot apparatus is configured to selectively rotate the storage container with respect to the base about a pivot axis;
a cooling device operably coupled to the storage container, wherein the cooling device is configured to selectively cool an interior portion of the storage container;
a lid in selective engagement with the storage container, wherein the lid selectively seals the opening of the storage container and generally confines the generally rigid condiment container within the interior portion of the storage container;
a dispensing tap operably coupled to the lid; and
a dispensing tube apparatus configured to selectively engage a port of the generally rigid condiment container, wherein the dispensing tube apparatus is configured to provide two fluid ducts between an interior volume of the generally rigid condiment container and an atmosphere that is exterior to the storage container, and wherein the dispensing tube apparatus is selectively coupled to the dispensing tap, wherein the dispensing tap is configured to selectively block the two fluid ducts between the interior volume of the generally rigid condiment container and the atmosphere.

2. The liquid condiment dispenser of claim 1, wherein the storage container is pivotally coupled to the base along a sidewall of the storage container via the pivot apparatus.

3. The liquid condiment dispenser of claim 2, wherein the pivot axis is generally perpendicular to the sidewall of the storage container.

4. The liquid condiment dispenser of claim 2, wherein the pivot axis is generally parallel to the sidewall of the storage container.

5. The liquid condiment dispenser of claim 1, further comprising a detent apparatus configured to limit the selective rotation of the storage container with respect to the base between a load position and a dispense position.

6. The liquid condiment dispenser of claim 5, wherein the load position and dispense position are 180 degrees apart.

7. The liquid condiment dispenser of claim 1, wherein the cooling device comprises a Peltier device.

8. The liquid condiment dispenser of claim 1, further comprising a temperature monitoring device configured to monitor a temperature of the interior portion of the storage container.

9. The liquid condiment dispenser of claim 1, wherein the generally rigid condiment container comprises a carton primarily comprised of one or more of cardboard and generally rigid plastic.

10. The liquid condiment dispenser of claim 1, wherein one or more of the lid and the storage container comprise a latch mechanism configured to selectively secure the lid to the storage container.

11. The liquid condiment dispenser of claim 1, further comprising thermal insulation associated with one or more of the storage container and lid, wherein the thermal insulation generally inhibits heat transfer between the interior portion of the storage container to the atmosphere when the opening of the storage container is sealed by the lid.

12. The liquid condiment dispenser of claim 1, wherein the dispensing tube apparatus comprises a liquid tube and a vent tube, therein generally defining the two fluid ducts.

13. The liquid condiment dispenser of claim 12, wherein the vent tube is configured to extend from the port a first distance into the generally rigid condiment container, and wherein the liquid tube is configured to extend from the port a second distance into the generally rigid condiment container, wherein the first distance is greater than the second distance.

14. The liquid condiment dispenser of claim 13, wherein the first distance is associated with a length of the generally rigid condiment container.

15. The liquid condiment dispenser of claim 14, wherein the second distance extends one inch or less into the generally rigid condiment container.

16. The liquid condiment dispenser of claim 13, wherein the dispensing tube apparatus comprises a cap configured to selectively engage the port of the generally rigid condiment container, wherein the two fluid ducts pass through the cap.

17. The liquid condiment dispenser of claim 16, wherein the dispensing tube apparatus comprises two compressible tubes extending from the cap to the atmosphere, wherein the two compressible tubes are respectively fluidly coupled to the liquid tube and vent tube via the cap, and wherein the dispensing tap comprises a pinch assembly configured to selectively compress the two compressible tubes, therein selectively blocking the two fluid ducts between the interior volume of the generally rigid condiment container and the atmosphere.

18. The liquid condiment dispenser of claim 17, wherein a dual lumen tube generally defines the two compressible tubes, wherein respective lumens of the dual lumen tube are fluidly coupled to the liquid tube and vent tube via the cap.

19. The liquid condiment dispenser of claim 1, wherein the port of the generally rigid condiment container comprises a threaded opening, and wherein the dispensing tube apparatus comprises a cap having an engagement portion configured to engage the threaded opening of the generally rigid condiment container, wherein the engagement portion comprises one or more of a thread, a barb, and a compressible seal configured to retain the cap to the threaded opening, and wherein the two fluid ducts pass through the cap.

20. A method for dispensing a perishable liquid, the method comprising:
providing a liquid condiment dispenser having a storage container pivotally coupled to a base;
rotating the storage container with respect to the base, therein placing the storage container in a loading position, wherein an opening of the storage container generally faces upwards;
attaching a dispensing tube apparatus to a pre-formed consumer package having a liquid residing therein;
placing the pre-formed consumer package within the storage container;
coupling the dispensing tube to a dispensing tap operably coupled to a lid;
securing the lid to the opening of the storage container; and
rotating the storage container with respect to the base, therein placing the storage container in a dispensing position, wherein the opening of the storage container generally faces downwards, and wherein the dispensing tap selectively permits dispensing of the liquid via an interaction between the dispensing tube apparatus and the dispensing tap and gravity.

21. The method of claim 20, further comprising selectively cooling the storage container.
